(19) United States
(12) Patent Application Publication
(10) Pub. No.: US 2026/0260910 A1
(43) Pub. Date: Sep. 3, 2026

(54) Fuel Cell System

(71) Applicant: Hydac Cooling GmbH, Sulzbach / Saar (DE)

(72) Inventors: Benjamin Theobald, Saarlouis (DE); Thomas Wolfanger, Neunkirchen (DE)

(73) Assignee: Hydac Cooling GmbH, Sulzbach / Saar (DE)

(21) Appl. No.: 19/164,009

(22) PCT Filed: Mar. 6, 2024
(86) PCT No.: PCT/EP2024/055786

§ 371 Date: Sep. 10, 2025

(30) Foreign Application Priority Data
Mar. 15, 2023 (DE) 10 2023 001 013.8

(51) Int. Cl. H01M 8/04029; H01M 8/04014

(52) U.S. Cl. CPC H01M 8/04029; H01M 8/04014

(57) ABSTRACT

The disclosure relates to a fuel cell system consisting of at least a fuel cell, a coolant circuit having a coolant pump and a heat exchanger, a water separator, and a fan, which generates a gaseous medium flow, in particular an air flow, in the direction of the heat exchanger, wherein by means of a cooling device, which has a conveying device, the water separated in the water separator reaches a discharge device which, by means of spray nozzles, sprays the water into the environment, wherein by means of the spray nozzles, the discharge device sprays the water in a direction opposite of the direction of the medium flow generated by the fan.

### CROSS-REFERENCE TO RELATED APPLICATIONS

This application claims priority to German Patent Application DE 10 2023 001 013.8, filed on Mar. 15, 2023 with the German Patent and Trademark Office. The contents of the aforesaid Patent Application are incorporated herein for all purposes.

### BACKGROUND

This background section is provided for the purpose of generally describing the context of the disclosure. Work of the presently named inventor(s), to the extent the work is described in this background section, as well as aspects of the description that may not otherwise qualify as prior art at the time of filing, are neither expressly nor impliedly admitted as prior art against the present disclosure.

The disclosure relates to a fuel cell system, comprising at least
a fuel cell,
a coolant circuit with a coolant pump and a heat exchanger,
a water separating device,
a fan, which generates a gaseous medium flow, in particular an air flow, through the heat exchanger,
   by means of a cooling device, which has a conveying apparatus, the water separated by means of the water separating device reaching a discharge device which, by means of spray nozzles, sprays the water into the environment.

A fuel cell is a device for converting chemical energy into electrical energy from a gaseous energy carrier gas, for example hydrogen, and a gaseous oxidant, for example in the form of ambient air. Typically, a plurality of fuel cells are combined with each other in a fuel cell stack to enable the desired output to be generated. In this case, stacks of 200 or more individual cells are not uncommon. The fuel cell stack receives a cathode reactant gas, regularly a flow of air which is driven through the stack via a compressor. In the process, not all of the oxygen is consumed by the stack and some of the air is discharged as a cathode exhaust gas, which can include liquid water and/or water vapour as a stack by-product. The fuel cell stack also receives an anode hydrogen reactant gas, which flows into the anode side of the stack and flow channels are also provided for a cooling fluid, which flows through the fuel cell stack in order that a thermal equilibrium can be maintained. Proton exchange membranes are frequently used for fuel cells.

To achieve efficient stack operation and a long stack service life, it is necessary to operate the respective fuel cell at an optimum relative humidity and in an optimum temperature range. A typical stack operating temperature is regularly between 60° C. and 80° C. The stack temperature provides for the relative humidity in the fuel cells in the stack for a certain stack pressure. Excessive stack temperatures above the optimum temperature can damage fuel cell components, which reduces the lifetime of the fuel cells.

Stack temperatures below the optimum operating temperature also reduce the stack output. Therefore, fuel cell systems use thermal subsystems which can control the temperature in the fuel cell stack.

One such thermal subsystem is disclosed in DE 10 2006 048 187 B4. The known solution relates to a fuel cell system for a vehicle, the system comprising:
a fuel cell stack, which provides a cathode discharge at a cathode discharge line, the cathode discharge comprising gaseous and liquid water;
a liquid water separator, which receives the cathode discharge from the cathode discharge line and separates liquid water therefrom; and
a thermal subsystem with a pump, a coolant circuit and a cooler, the pump pumping a cooling fluid through the coolant circuit, the cooler and the fuel cell stack, the cooler comprising a selectively permeable wall portion, which allows water in the cooling fluid flowing through the cooler, to pass through and be evaporated on an outer surface of the wall portion; and
the thermal subsystem further comprising a coolant reservoir to which the liquid water, which is separated from the cathode discharge by the water separator, is supplied, and from which the separated water is fed into the coolant circuit to maintain the water supply thereof when required.

The selectively permeable wall portion in the known solution comprises a cross-linked polyvinyl alcohol on a polyethersulfone substrate or has a cross-linked chitosan membrane, which can become clogged with dirt in rough everyday use, particularly in the context of vehicle operation, and can render them unusable. These selectively permeable substrate or membrane solutions are also relatively expensive to implement for the heat exchanger.

DE 10 2008 029 529 A1 discloses a method for operating a fuel cell system in a motor vehicle, which has at least one fuel cell, from which water-carrying exhaust gas is emitted during operation, a cooling circuit system being provided in the motor vehicle, in which a cooling fluid is routed to a heat source in order to absorb heat there, the cooling fluid being routed to a cooling region in which the cooling fluid releases the absorbed heat to the ambient air via walls, the method comprising the step that water from the exhaust gas, in particular after deposition, is collected in a container, and the water collected in the container being at least partially applied to the outside of the walls in the cooling region. Typically, the cooling region is then configured as a cooler, for example as a fin cooler, and, when the motor vehicle is being driven, the airstream promotes the removal of water droplets from the cooler, which simply entrains the water droplets in the air flow. In the known solution, however, the airstream also promotes evaporation of the water droplets, consequently enabling the cooler and thus the cooling fluid in the cooler to be cooled.

### SUMMARY

A need exists to provide an improved fuel cell system and cooling assembly, which is inexpensive to implement, functionally reliable in use and/or leads to further improved cooling results.

The need is addressed by the subject matter of the independent claim(s). Embodiments of the invention are described in the dependent claims, the following description, and the drawings.

### BRIEF DESCRIPTION OF THE DRAWINGS

The drawings show, in the manner of a fluidic recirculation system:

FIG. 1 a first embodiment of an example cooling solution;

FIG. 2 a modified embodiment of the example solution according to FIG. 1; and

FIG. 3 components of a cooling apparatus used in FIGS. 1 and 2 in an exploded view.

### DESCRIPTION

The details of one or more embodiments are set forth in the accompanying drawing and the description below. Other features will be apparent from the description, drawing, and from the claims.

In the following description of embodiments of the invention, specific details are described in order to provide a thorough understanding of the invention. However, it will be apparent to one of ordinary skill in the art that the invention may be practiced without these specific details. In other instances, well-known features have not been described in detail to avoid unnecessarily complicating the instant description.

In some embodiments, a discharge device sprays the water by means of the spray nozzles in a direction contrary to the direction of the medium flow generated by the fan means that technically complex, selectively permeable wall portions, such as cross-linked chitosan membranes, can be dispensed with, which helps to reduce manufacturing costs and increases the functional reliability of the fuel cell system during operation. In particular, the solution according to the teachings herein is not susceptible to contamination from the environment. Due to the electrical efficiency of the fuel cell, which can be estimated at approx. 50%, it is clear that a large proportion of the energy supplied must be discharged as heat. With low-temperature fuel cells in particular, this results in the requirement for large cooling devices, since the temperature difference between the ambient air and the fuel cell temperature to be maintained is only small. With the fuel cell system and cooling device per the teachings herein, such small temperature differences in low-temperature fuel cells can be safely controlled with little technical equipment outlay. The statement that, by means of the spray nozzles, the water is sprayed in a direction contrary to the direction of the medium flow generated by the fan, facilitates an adiabatic cooling process in a particularly beneficial manner. In this way, the water droplets emitted by the spray nozzles can be atomised directly in gaseous form, so that this associated adiabatic change of state from “liquid” to “gaseous” allows large amounts of heat to be dissipated from the system, which significantly increases the cooling capacity. This thus has no equivalent in prior art.

The process water arising during operation of the respective fuel cell is used to cool the air flow adiabatically via the heat exchanger, which is used for cooling the fuel cell by means of the spray discharge device, taking into account the reversal of direction. The resulting situation for cooling is that the air impinging on the heat exchanger has a lower temperature than the ambient air. This temperature drop means that a greater cooling capacity can be achieved with the same heat exchangers, as shown in prior art. Consequently, this extends the temperature range in which the fuel cell can be operated or, conversely, the heat exchanger or the coolant circuit of the fuel cell system connected thereto can be reduced in size, which in turn saves costs.

The solution according to the teachings herein is of particular interest in the context of adiabatic building cooling. Furthermore, it is beneficial if a hood or housing design for vehicles or stationary machines is designed in any case in such a manner that any effects due to undesirable air flows from the environment on the sprayed water are minimised.

The disclosure further relates to a cooling apparatus as a subsystem for the previously presented fuel cell system and the use of such a cooling apparatus for an aforementioned fuel cell system.

In some embodiments, it is provided that the spray nozzles of the discharge device are arranged between the fan and the heat exchanger in such a manner that the spray nozzles spray into the fan slipstream on the outlet side of the fan. In this case, the spray nozzles spray the water contrary to the air flow generated by the fan into a space between this fan and the heat exchanger. The fan, which is regularly designed with at least one axial fan, accordingly draws in ambient air on the inlet side, forming a wake, and expels the air drawn in at an accelerated rate on the outlet side in the direction of the heat exchanger, in the so-called slipstream. In particular, the air flow passes through the heat exchanger. Furthermore, the heat exchanger can also be arranged between the spray discharge device and the fan. For example, the fan then draws in the ambient air through the heat exchanger and the spray discharge device in turn sprays the water mist contrary to the direction of the air flow, which results in improved mist formation.

In some embodiments, viewed in the flow direction of the medium flow generated by the fan, it is provided that the spray nozzles of the discharge device are arranged upstream of said fan, which is followed by the heat exchanger in such a manner that the spray nozzles spray into the fan wake on the inlet side of the fan. This results in a longer route for the water droplets emitted by the spray nozzles, which helps to facilitate the adiabatic phase transition from “liquid” to “gaseous” to produce the atomised cooling medium.

In some embodiments, it is provided that a collecting container is connected between the water separator and the feed pump in the conduit of the discharge device. If the respective fuel cell generates too much water, this can be stored in the collecting container, which can also supply the spray nozzles of the discharge device if there is too little water. In this case, the collecting container for example has a dispensing device for hydrogen. During fuel cell operation, hydrogen can enter the cooling fluid channels unintentionally due to leakage, where it is dissolved in the cooling fluid in the form of water or is entrained in the cooling fluid as hydrogen bubbles. This accumulation of hydrogen in the cooling water can be outgassed accordingly in the collecting container and for example put to some kind of use. If no use is provided, the hydrogen gas which accumulates on the environment side of the collecting container can also be burnt off. For example, it can be provided that the discharge device is part of a closed adiabatic cooling circuit, which is connected on the inlet and outlet side to the collecting container, which helps to prevent cooling losses.

In this respect, the fan is a turbomachine externally driven by means of a motor, for example in the form of an electric motor, which turbomachine conveys air as a gaseous medium from an inlet side (fan wake) of the fan to its outlet side (fan slipstream), which is opposite the heat exchanger, for example in the form of a plate heat exchanger, so that the fan can then force the air drawn in from the environment through the gaps kept free between the fins of the heat exchanger. In particular, an axial fan is used and the fan blades of the fan can bring about a laminar axial flow, at least on the outlet side of the fan, with a correspondingly high cooling input into the heat exchanger.

The water from the respective spray nozzle of the discharge device, which is present in atomised form, can be collected centrally, particularly in a stationary application, and can be returned to a water circuit, for example as part of a building water supply. In a mobile application, the water can also be captured and collected; however, it is also possible to simply discharge the emitted water into the environment in pure form, for example like the condensate produced by vehicle air conditioning systems.

In some embodiments, it is provided that the water separating device has a dispensing device for cathode exhaust gas. The cathode discharge, which in particular contains ambient air, can be separated in this way from the liquid water from the fuel cell system and thus reduces the entrainment of gas bubbles in the spray water provided for the discharge device.

A cooling apparatus as a subsystem for such a fuel cell system consists at least of
a water separating device,
a coolant pump,
a heat exchanger,
a coolant circuit connected to the heat exchanger, and
a fan, which generates a gaseous medium flow, in particular an air flow, through the heat exchanger,
   a feed pump of a conveying device conveying fluid from the water separating device to a discharge device which, by means of spray nozzles, sprays the fluid into the environment and, by means of the spray nozzles, the discharge device spraying the water in a direction contrary to the direction of the medium flow generated by the fan.

The fuel cell system and the associated cooling apparatus are discussed in greater detail below with reference to further embodiments according to the FIGS. The FIGS. are schematic and not necessarily to scale.

Specific references to components, process steps, and other elements are not intended to be limiting. Further, it is understood that like parts bear the same or similar reference numerals when referring to alternate FIGS.

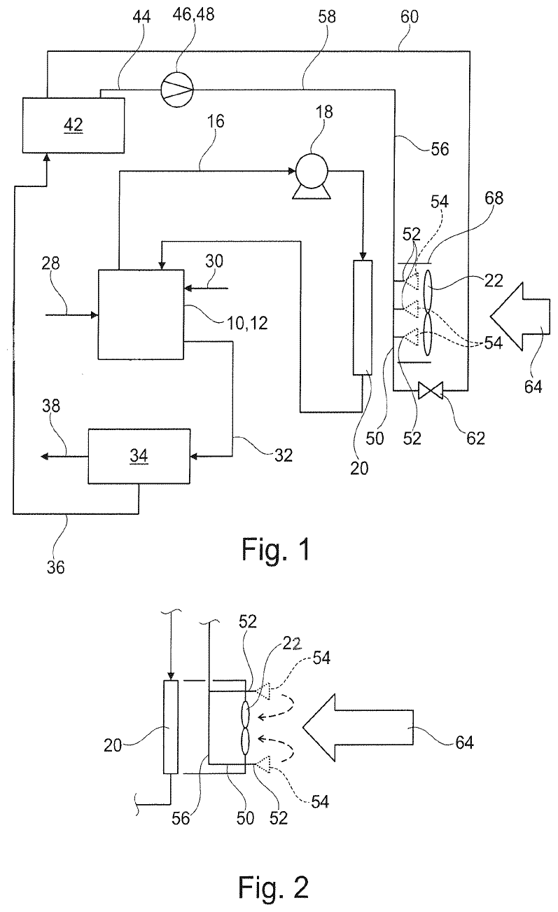

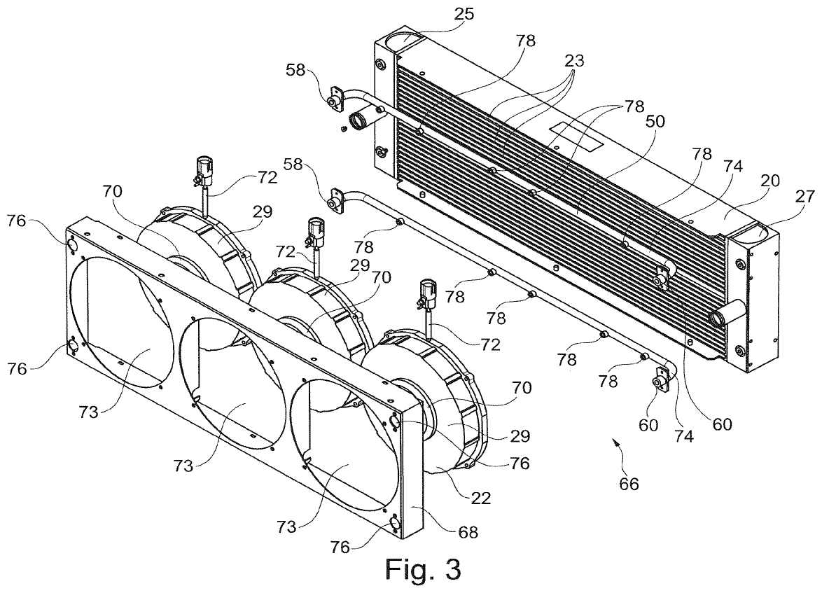

The fuel cell system shown as a whole in FIG. 1 has a fuel cell stack 10 with a plurality of individual, correspondingly interconnected fuel cells 12. The fuel cell stack 10 has proton exchange membranes (not shown). Furthermore, the system has a coolant circuit 16 with a coolant pump 18 and a heat exchanger 20, for example in the form of a cross-flow heat exchanger with its individual cooling fins 23 as shown in FIG. 3. Such coolant circuits 16 with their individual components are common for fuel cell systems, with the result that they will not be discussed in greater detail at this point. The cooling fluid used for the coolant circuit 16 is regularly a mixture of ethylene glycol and water with varying concentrations in the Composition and is supplied or discharged via distributor pipes 25 and 27, respectively, which are laterally adjacent to individual flow channels, the flow channels being connected in a fluid-conducting manner to the distributor pipes 25, 27 in the usual manner for guiding a fluid to be heat-controlled, in particular to be cooled. The individual flow channels are kept apart from one another plate by plate via fins 23, which form an air-side ribbing pattern as part of the plate structure and in this respect serve as surface expansion for the heat exchanger, which guides the air flow of a fan 22. In any case, the glycol ensures that the water cannot freeze even at low temperatures. To improve the cooling capacity of the heat exchanger 20, the fan 22, for example in the form of three identically constructed axial fans 29, is arranged upstream of the heat exchanger 20.

The fuel cell stack 10 shown as a whole and simplified in a block diagram has an anode side and a cathode side in the usual manner. The anode side receives a hydrogen input gas via the supply line 28. In addition, the cathode side receives an air flow via the supply line 30. An aqueous cathode discharge takes place on the outlet side of the fuel cell stack 10 via a discharge line 32, which is connected to a water separating device 34 of conventional design, which separates water from the cathode discharge and discharges liquid water to a discharge line 36. The water separating device 34 can consist of a conventional water separator, which is used to mechanically separate water droplets from a gas flow. For example, however, water is physically separated from the gas flow by condensation. The cathode gas is discharged from the water separating device 34 via a line 38. If the fluid pressure in the discharge line 36 is sufficient, fluid enters a collecting container 42. A conveying device 46, for example in the form of a pressure pump 48, which by way of example has a delivery pressure of 5 to 15 bar for the fluid, such as water, is connected on the delivery side of the collecting container 42 in a corresponding discharge line 44. In this respect, the discharge line 44 establishes a fluid-conducting connection between the pressure pump 48 and a discharge device denoted as a whole by 50 which, in the embodiment shown, has three individual spray nozzles 52 arranged one above the other. In rows and columns, a plurality of such spray nozzles 52 can also be arranged in groups in relation to each other, with the arrangement for example being selected at any rate in such a manner that the free front face of the heat exchanger 20 is substantially reached by a spray application from the discharge device 50. An associated embodiment is explained in greater detail in FIG. 3. The individual spray cones 54 generated by means of the nozzles 52 are indicated by dotted lines in the diagram of the FIG. The flow directions of the fluids in the associated lines are indicated in turn by arrows.

During operation of the fuel cell stack 10, heat is generated which is transferred via the closed coolant circuit 16 to the heat exchanger 20. For this purpose, the coolant pump 18 removes the heated cooling fluid from the fuel cell stack 10 and, after cooling via the heat exchanger 20, the cooled cooling fluid is delivered to the fuel cell stack 10 for renewed coolant circulation.

In addition, the process water inevitably arising during fuel cell operation is passed on via the water separating device 34 and the collecting container 42 by using the pump 48 via the discharge line 44 to the discharge device 50. Then, under the action of the pump 48, spray application takes place in the direction of the fan 22 via the spray nozzles 52. At the same time, the water-spray discharge, regularly in the form of a water mist, mixes with the ambient air drawn in by means of the fan 22, which results in cooling of the air on the discharge side of the fan 22, i.e. before it passes through the cooling fins of the heat exchanger 20. The air cooled adiabatically in this manner by means of the water mist increases the cooling capacity of the heat exchanger 20 and thus leads overall to an improvement of the cooling capacity in the coolant circuit 16. In addition to adiabatic cooling due to the discharge of spray water, in the form of mist, into the air, convective cooling processes are also added by using the fan 22. The cooling apparatus according to the teachings herein, which, within the framework outlined, can also be retrofitted to existing fuel cell systems, is particularly suitable for use with low-temperature fuel cells, since the temperature difference between the ambient air and the fuel cell temperature to be maintained is small and, with the cooling apparatus, effective cooling is easily achieved in terms of technical equipment, without it being necessary to use correspondingly large-volume cooling devices. Suitably good cooling capacities can be achieved if a closed adiabatic circuit 56 is implemented with a feed line 58 from the collecting container 42 via the conveying device 46 or the pressure pump 48 to the discharge device 50 and from there back to the collecting container 42 by means of a return line 60. In this respect, the said circuit 56 is closed, except for the discharge via the individual nozzles 52. A shut-off valve 62, which is connected in the return line 60 downstream of the spray nozzles 52, viewed in the direction of fluid flow, can be used to interrupt the aforementioned circuit 56. Instead of the recirculation system 56 shown, it is also possible to provide only one feed line 58 to the spray nozzles 52 and excess fluid, which is not sprayed by the spray nozzles 52, is discharged into the environment or into a collecting tray, not shown, on the underside of the discharge device 50.

The fan 22 has an intake direction 64 for ambient air, which is transported in an axial direction by means of the fan blades of the fan 22 towards the spray nozzles 52 of the discharge device 50. The aforementioned three individual spray nozzles 52 then spray the water, forming individual spray cones 54, in a direction which is contrary to the axial fan direction or intake direction 64 of the fan 22. The air flow cooled in this manner then passes from the fan 22 into the gaps between the fins 23 of the heat exchanger 20. For example, in this case, the fan 22 with its axial fans 29, the heat exchanger 20 and the spray nozzle discharge device 50 are combined in one unit 66 in a common housing 68. In an embodiment which is not shown in greater detail, however, it is alternatively possible to place the fan 22 on the other, opposite side of the heat exchanger 20, so that the heat exchanger 20 comes to rest between the fan 22 and the spray discharge device 50. In this respect, the fan 22 then draws in the ambient air through the heat exchanger 20, again resulting in a flow pattern with the intake direction 64. In this respect, the spray discharge with the water mist then also continues to be contrary to the intake direction 64.

The further modified embodiment according to FIG. 2 relates to a lower right-hand section of FIG. 1, again with heat exchanger 20, fan 22 and discharge device 50. Otherwise, the solution according to FIG. 1 relating to the fuel cell stack 10 is retained; likewise the connection lines shown for the heat exchanger 20 and for the discharge device 50.

Compared to the solution according to FIG. 1, this is modified in that the individual spray nozzles 52, here in the form of two spray nozzles 52, now protrude beyond the fan 22 in the direction of its intake direction 64, the spray cone discharge 54 again taking place contrary to the intake direction 64; however, the water droplets are then deflected by approximately 180° and, entrained by the intake flow of the fan 22, pass the fan 22 parallel to the intake direction 64 and, atomised in this manner, then impinge on the heat exchanger 20 with its individual fins 23. In this way, compared to the solution according to FIG. 1, the path of the water droplets after discharge is extended, which helps to facilitate the adiabatic conversion processes from “liquid” to “gaseous”. In this respect, even better cooling capacities can be achieved, if required, with the configuration according to FIG. 2 than with the solution according to FIG. 1. Furthermore, FIG. 2 shows an open recirculation system without return line 60. In this respect too, the fan 22 can be positioned on the other side of the heat exchanger 20 which is directed away from the spray nozzles 52.

The cooling device for the fuel cell stack 10 used in FIGS. 1 and 2 is explained in greater detail below with reference to a possible embodiment. In this case, FIG. 3 shows an exploded view of a plate heat exchanger, as a so-called cross-flow heat exchanger, as heat exchanger 20. Between two distributor pipes 25 and 27, one as an inlet and one as an outlet for a cooling fluid, such as a water/glycol mixture, there are flow channels extending parallel to one another, which guide the fluid to be cooled, such as hydraulic medium from working hydraulics, and between the flow channels there are fins 23, which maintain equally spaced, free intermediate spaces for guiding the air in the usual manner. The aforementioned construction of a heat exchanger 20 is conventional, with the result that it will not be discussed in greater detail at this point.

On the opposite side and consequently directed towards the observer of FIG. 3, the fan 22 is shown with its three axial fans 29, which can be accommodated in a housing 68. Directed towards the housing 68, the respective axial fan 29 has grid-shaped apertures to enable air to be drawn in from the environment. The aforementioned wire structure, which is not shown in greater detail and is otherwise a conventional measure in axial fan construction, protects the fan blades, not shown in greater detail, of the respective axial fan 29 from damage and also protects operating staff from injury during operation. Furthermore, the respective axial fan 29 has an electric motor 70 in the centre for driving its fan blades in the usual manner, which also receives its supply current in the usual manner via electrical connecting cables 72, each of which has a type of screw terminal at its free end for connecting the fan 22 to an electrical supply network, not shown in greater detail. The individual axial fans 29 are fixed in the housing 68 and, during operation, the air flows through the respective axial fan 29 in the intake direction 64 from right to left via the circular fan openings 73 in the housing 68, as seen in the viewing direction of FIG. 3. The axially directed air is then blown through the gaps between the individual fins 23 of the heat exchanger 20, the cooling air escaping to the environment 20 again on the right-hand side after flowing through the heat exchanger 20. In this way, the fluid to be cooled, which is guided in the fins 23, is cooled by the air flow, and hot cooling fluid is fed in via the first distributor pipe 25 and then, accordingly cooled, is discharged from the heat exchanger 20 for its further use via the second distributor pipe 27.

As further shown in FIG. 3, the discharge device 50 for discharging water is arranged between the heat exchanger 20 and the fan 22. In this region, the discharge device 50 has two pipes 74 extending parallel to each other as part of a pipe linkage 75, which, as shown in the diagram according to FIG. 1, are connected at the end in each case to the supply line 58 on the one hand and to the return line 60 on the other. In FIG. 3, the aforementioned lines 58, 60 are only indicated as sections. Furthermore, the pipes 74 extending in a straight line are screwed to associated cut-outs 76 in the housing 68.

The respective pipe 74 has stub-like openings 78, four in total for each pipe 74, which are arranged in groups at different distances from each other. A so-called hollow cone nozzle, which is not shown in greater detail, is inserted into the respective circular cylindrical opening 78, which as a precision nozzle enables the atomisation of liquid droplets, which, in the atomised state, are introduced into the air flow of the fan 22 contrary to the blowing direction of said fan, which leads to further cooling of the cooling air flow and therefore to improved cooling results at the heat exchanger 20. This thus has no equivalent in prior art.

The invention has been described in the preceding using various example embodiments. Other variations to the disclosed embodiments may be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor, device, or other unit may be arranged to fulfil the functions of several items recited in the claims. Likewise, multiple processors, devices, or other units may be arranged to fulfil the functions of several items recited in the claims.

The term “exemplary” used throughout the specification means “serving as an example, instance, or exemplification” and does not mean “preferred” or “having advantages” over other embodiments. The terms “in particular” and “particularly” used throughout the specification means “for example” or “for instance”.

The mere fact that certain measures are recited in mutually different dependent claims or embodiments does not indicate that a combination of these measures cannot be used to advantage. Any reference signs in the claims should not be construed as limiting the scope.

What is claimed is:

1-10. (canceled)

11. A fuel cell system, comprising at least:
a fuel cell;
a coolant circuit with a coolant pump and a heat exchanger;
a water separator; and
a fan, which generates a gaseous medium flow, in particular an air flow, through the heat exchanger;
wherein using a cooling assembly, which has a conveyor, the water separated in the water separator reaches a discharge device which, using spray nozzles, sprays the water into the environment;
wherein, using the spray nozzles, the discharge device sprays the water in a direction contrary to the direction of the medium flow generated by the fan.

12. The fuel cell system of claim 11, wherein the spray nozzles of the discharge device are arranged between the fan and a heat exchanger in such a manner that the spray nozzles spray into the fan slipstream on the outlet side of the fan.

13. The fuel cell system of claim 11, wherein the spray nozzles of the discharge device are arranged upstream of the fan, viewed in the flow direction of the medium flow generated by the fan, which is followed by the heat exchanger in such a manner that the spray nozzles spray into the fan wake on the inlet side of the fan.

14. The fuel cell system of claim 11, wherein a collecting container is connected between the water separator and the conveyor in the line guide of the discharge device.

15. The fuel cell system of claim 14, wherein the discharge device is part of a closed adiabatic cooling circuit, which is connected on the inlet and outlet side to the collecting container.

16. The fuel cell system of claim 14, wherein the collecting container has a dispensing device for hydrogen.

17. The fuel cell system of claim 11, wherein a plurality of fuel cells are combined to form a stack, each having a feed for hydrogen and a feed for oxygen.

18. A cooling assembly for a fuel cell system, comprising at least:
a water separator;
a coolant pump;
a heat exchanger;
a coolant circuit connected to the heat exchanger; and
a fan, which generates a gaseous medium flow through the heat exchanger;
wherein a feed pump of a conveyor conveys fluid from the water separator to a discharge device which, using spray nozzles, sprays the fluid into the environment; wherein using the spray nozzles, the discharge device sprays the water in a direction contrary to the direction of the medium flow generated by the fan.

19. The cooling assembly of claim 18, wherein the heat exchanger is formed from a cross-flow heat exchanger; wherein the fan consists of a plurality of axial fans; and wherein the discharge device has at least one fluid-conducting pipe linkage into which individual hollow cone nozzles as spray nozzles are inserted for the adiabatic generation of atomised cooling gas from liquid water.

20. A method of using a cooling apparatus of claim 18 for a fuel cell system, wherein the water obtained during operation of the respective fuel cell is passed on using a conveyor to a discharge device which, using spray nozzles, sprays water into the air conveyed by the fan of the heat exchanger contrary to the air flow direction, in order to generate adiabatic cooling for the purpose of cooling down the coolant in the coolant circuit of the respective fuel cell.

21. The fuel cell system of claim 12, wherein the spray nozzles of the discharge device are arranged upstream of the fan, viewed in the flow direction of the medium flow generated by the fan, which is followed by the heat exchanger in such a manner that the spray nozzles spray into the fan wake on the inlet side of the fan.

22. The fuel cell system of claim 12, wherein a collecting container is connected between the water separator and the conveyor in the line guide of the discharge device.

23. The fuel cell system of claim 13, wherein a collecting container is connected between the water separator and the conveyor in the line guide of the discharge device.

24. The fuel cell system of claim 15, wherein the collecting container has a dispensing device for hydrogen.

25. The fuel cell system of claim 12, wherein a plurality of fuel cells are combined to form a stack, each having a feed for hydrogen and a feed for oxygen.

26. The fuel cell system of claim 13, wherein a plurality of fuel cells are combined to form a stack, each having a feed for hydrogen and a feed for oxygen.

27. The fuel cell system of claim 14, wherein a plurality of fuel cells are combined to form a stack, each having a feed for hydrogen and a feed for oxygen.

28. The fuel cell system of claim 15, wherein a plurality of fuel cells are combined to form a stack, each having a feed for hydrogen and a feed for oxygen.

29. The fuel cell system of claim 16, wherein a plurality of fuel cells are combined to form a stack, each having a feed for hydrogen and a feed for oxygen.
